(19) United States
(12) Patent Application Publication
(10) Pub. No.: US 2015/0089137 A1
(43) Pub. Date: Mar. 26, 2015

(54) Managing Mirror Copies without Blocking Application I/O

(71) Applicant: International Business Machines Corporation, Armonk, NY (US)

(72) Inventors: Matthew T. Brandyberry, Austin, TX (US); Ninad S. Palsule, Bangalore (IN)

(73) Assignee: International Business Machines Corporation, Armonk, NY (US)

(21) Appl. No.: 14/074,029

(22) Filed: Nov. 7, 2013

Related U.S. Application Data
(63) Continuation of application No. 14/033,655, filed on Sep. 23, 2013.

(51) Int. Cl. G06F 3/06; G06F 12/10; G06F 12/08

(52) U.S. Cl. CPC G06F 3/065; G06F 12/0802; G06F 12/1027; G06F 3/0604; G06F 3/0683
USPC 711/118

(57) ABSTRACT

Mechanisms, in a data processing system comprising a processor and an address translation cache, for caching address translations in the address translation cache are provided. The mechanisms receive an address translation from a server computing device to be cached in the data processing system. The mechanisms generate a cache key based on a current valid number of mirror copies of data maintained by the server computing device. The mechanisms allocate a buffer of the address translation cache, corresponding to the cache key, for storing the address translation and store the address translation in the allocated buffer. Furthermore, the mechanisms perform an input/output operation using the address translation stored in the allocated buffer.

### BACKGROUND

The present application relates generally to an improved data processing apparatus and method and more specifically to mechanisms for managing mirror copies without blocking application input/output (I/O) in a clustered file system.

In modern clustered file systems, i.e. file systems which are shared by being simultaneously mounted on multiple servers, such as is provided by the Advanced Interactive Executive (AIX) Virtual Storage Server available from International Business Machines Corporation of Armonk, N.Y., metadata management is done by separate metadata server nodes (server) while applications are run on client nodes (client) where the file system is mounted. In this configuration, the client reads and writes application data directly from storage by using an address translation provided by the server. The client caches the translation to reduce server communication. In some cases, the clustered file system mechanisms of the server may implement integrated volume management or other virtualization mechanisms. This causes the client to need to cache various levels of translations, such as a translation between a logical address and a virtual address, and a translation from a virtual address to a physical address.

### SUMMARY

In one illustrative embodiment, a method, in a data processing system comprising a processor and an address translation cache, for caching address translations in the address translation cache. The method comprises receiving, by the data processing system, an address translation from a server computing device to be cached in the data processing system. The method also comprises generating, by the data processing system, a cache key based on a current valid number of mirror copies of data maintained by the server computing device. Moreover, the method comprises allocating, by the data processing system, a buffer of the address translation cache, corresponding to the cache key, for storing the address translation. In addition, the method comprises storing, by the data processing system, the address translation in the allocated buffer. Furthermore, the method comprises performing, by the data processing system, an input/output operation using the address translation stored in the allocated buffer.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3A is an example diagram illustrating a plurality of logical storage partitions associated with a plurality of mirror copies of data in accordance with one illustrative embodiment;

FIG. 3B illustrates an example scenario in which the second data mirror has been removed and a new mirror copy of data has been added in accordance with one illustrative embodiment;

FIG. 4A is an example diagram illustrating a cache buffer allocation scheme that may be implemented by a client computing device to cache address translations in accordance with one illustrative embodiment;

FIG. 4B is an example diagram of an address translation cache after a change in the number of mirror copies of data has been communicated to the client computing device in accordance with one illustrative embodiment;

FIG. 5 is a flowchart outlining an example operation of a virtual storage server when performing a change in a number of mirror copies of data maintained by the backend storage in accordance with one illustrative embodiment;

FIG. 6 is a flowchart outlining an example operation of a client computing device when caching an address translation for an I/O operation in accordance with one illustrative embodiment; and

FIG. 7 is a flowchart outlining an example operation of a client computing device for managing an address translation cache in response to a change in a number of mirror copies of data at a backend store in accordance with one illustrative embodiment

### DETAILED DESCRIPTION

As mentioned above, in modern clustered file systems, such as the Advanced Interactive Executive (AIX) Virtual Storage Server available from International Business Machines Corporation of Armonk, N.Y., the client computing device must obtain address translations from the metadata server, which implements the clustered file system, and must cache the various levels of address translations at the client computing device to minimize server communications. Moreover, the clustered file system mechanisms may provide features for adding/removing mirror copies of data, which in turn changes the virtual to physical address translations for a logical storage partition of a storage system, where a “logical storage partition” in the present context refers to a logical division of a storage system's storage space so that each logical storage partition (LSP) may be operated on independent of the other logical storage partitions of the storage system. For example, a storage system may be logically partitioned into multiple logical storage partitions, one for each client computing device. If multiple client computing devices cache such address translations, when these translations change due to the adding/removing of mirror copies of the data, problems may occur with regard to cache coherency over these multiple client computing devices, i.e. some client computing devices may have inaccurate address translations cached locally pointing to old or stale mirror copies of the data.

This situation may be addressed in a number of different ways. First, the metadata server (server hereafter) may revoke and block translation access for all client computing devices while adding or removing a mirror copy. While this is relatively simple to implement, it results in a large performance degradation for application input/output (I/O) operations since these operations are blocked while the mirror copy is being added/removed. Second, the server may also revoke access to each logical storage partition of the storage device on an individual basis, before changing a mirror copy, and then re-establish access to the logical storage partition(s) after the adding/removing of the mirror copy is completed. However, this second approach may cause longer delays in the application I/O operations due to blocking these I/O operations while the mirror copy addition/removal is being performed. Furthermore, the mirror copy add/remove operations must be atomic since partial failures of such operations are difficult to recover from.

The illustrative embodiments provide mechanisms for managing mirror copies without blocking application input/output (I/O) in a clustered file system. Typically, these application IO operations cause read/write requests to be submitted by these applications for accessing files stored in the physical storage devices of a backend storage system with which a virtual storage server is associated. When such an I/O operation is performed by the client computing device, the client computing device converts the logical address used by the application to a virtual address associated with the logical storage partition associated with the client computing device and the particular file for which access is sought. From the virtual address, the client computing device obtains the logical storage partition number associated with the file. The client computing device then checks its own local cache to determine if a translation is present for the virtual address and logical storage partition. If not, then a translation request is sent to the virtual storage server and the server returns the information which the client computing device uses to populate a corresponding buffer in the cache.

With the mechanisms of the illustrative embodiments, in one illustrative embodiment, a client computing device caches address translations for one or more logical storage partitions of a virtual storage of a virtual storage server in a single buffer where the buffer is hashed and the number of mirror copies of data in the virtual storage server is part of the hash key, or cache key. Thus, the virtual storage server does not need to revoke and block the translation when mirror copies are added/removed and instead will perform a metadata processing in which each client computing device is requested to release buffers whose key represents an old number of mirror copies. All new I/O requests create a new buffer with newer number of mirror copies and fetches the translation from the virtual storage server. Thus, some I/O operations, such as those already “in-flight”, may use old buffers while new I/O operations will use new buffers. The old buffers will get recycled once all the old I/O operation references to the old buffers are released leaving only the new buffers and new translations valid for use by the new I/O operations.

As an example, assume that there are two mirror copies of data on a virtual storage server and application I/O operations have caused address translations to be cached on a client computing device where each logical storage partition associated with the client computing device has two physical partitions (one for each of the two mirror copies) associated with it. The client computing device stores the address translations in buffers where each buffer contains an address translation for multiple logical storage partitions.

With the illustrative embodiments, the buffer is allocated from cache memory of the client computing device and the cache key for the buffer in the cache is a tier id (which may be eliminated or set to a default value if a single tiered storage system is being used or may be a value indicative of a particular tier within a multi-tiered storage system), a first logical storage partition number, and a number of mirror copies. In this example, the client computing device may have address translations for a particular logical storage partition cached in a buffer of the cache having a corresponding key of (SYSTIER, 0, 2).

Now, assume that an administrator initiates an operation to remove one of the mirror copies of data. The command is processed on the virtual storage server which checks if mirror copy removal is possible and then marks the second mirror copy of each logical storage partition as being stale, out-of-date, or invalid. The virtual storage server then changes the number of mirror copies in the metadata of the virtual storage server from 2 to 1 and updates the metadata of the logical storage partitions so that they each only have a single copy of the data. This is a long running operation and no application I/O operations are affected.

Once the virtual storage server side operations are committed on the backend storage, the virtual storage server sends a mirror copy change message to the client computing devices to request that they release old address translations and further to inform the client computing devices of the new number of mirror copies of data. At the client computing device, the mirror copy change message received from the virtual storage server is processed by having the client computing device first mark in the cache metadata that the number of mirror copies of data have changed from 2 to 1 such that after this update, all new I/O operations will allocate buffers in the cache for address translations using the new number of mirror copies. The client computing device then checks all of the keys of the address translation buffers in the cache to determine which address translation buffers are associated with keys using the old number of mirror copies. If an address translation buffer is found that is using the old number of mirror copies, it is marked in the cache for recycling after all references on the buffer are released. A count of such buffers may be maintained so that a determination can later be made as to whether all address translation buffers using old number of copies have been released for recycling.

Once all of the address translation buffers in the cache that utilize the old number of copies, i.e. “old buffers”, are released by the client computing device I/O operations for recycling, these buffers may be reused for new address translations using the new number of copies of data. The client computing device may send a message back to the virtual storage server informing the virtual storage server that all old buffers have been released. In response to receiving this message from all of the client computing devices, the virtual storage server may then complete its removal of the mirror copy of data.

It should be appreciated that similar operations as described above for the removal of a mirror copy of data may also be used for the addition of a new mirror copy of data in the virtual storage system. However, it should be appreciated that with the addition of a new mirror copy of data, in the above operation the virtual storage server does not need to mark new copies stale as they are by default created with a stale attribute which is then updated to a fresh state when the new copy is synced.

Thus, with the mechanisms of the illustrative embodiments, the number of mirror copies of data in a virtual storage server may be modified without having to block application I/O operations. Application I/O operations that utilize address translations for an old number of mirror copies may continue to be processed using the old buffers after initiating the change in the mirror copies while the modification to the mirror copies is being performed. New application I/O operations occurring after initiating the change in the mirror copies will utilize address translations for the new number of mirror copies and new buffers allocated in the cache for these address translations. As a result, application I/O operations are not blocked while changes to the mirror copies of data are performed in the virtual storage server.

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium is a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium is any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Similarly, a computer readable storage medium is any computer readable medium that is not a computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

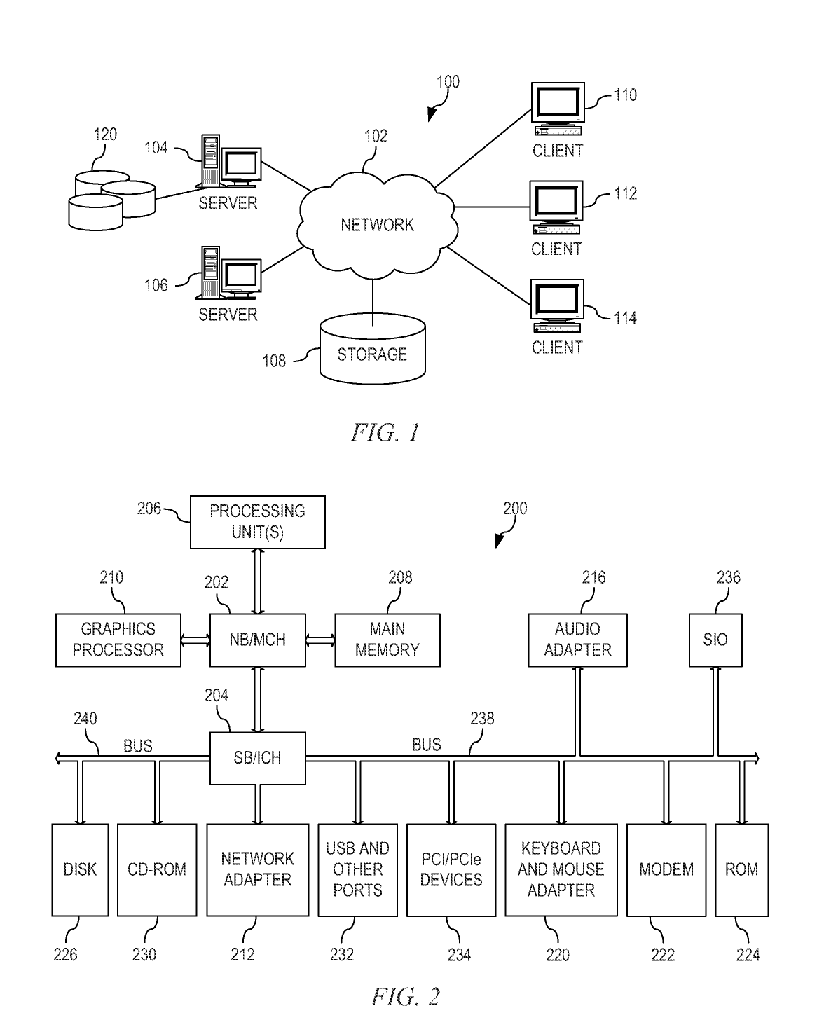

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

With reference again to FIG. 1, one or more of the servers 104, 106 may implement a virtual storage server, such as by executing an operating system that supports virtual storage server capabilities, e.g., AIX Virtual Storage Server, or the like. A server computing device implementing such virtual storage server mechanisms will hereafter be referred to as a “virtual storage server.” For purposes of the following description, it will be assumed that server 104 implements virtual storage server mechanisms and thus, is a virtual storage server 104. The virtual storage server 104 provides access to logical storage partitions, of backend physical storage devices 120 associated with the virtual storage server 104, to client computing devices 110-114. The logical storage partitions provide the appearance to the client computing devices 110-114 that the client computing devices 110-114 are being provided with a single contiguous storage device and a contiguous storage address region, even though the logical storage partition is backed by the backend physical storage devices 120 and may be distributed across these physical storage devices by way of virtualization mechanisms implemented in the virtual storage server.

In providing the logical storage partitions to the client computing devices, the virtual storage server 104 performs address translation operations to generate virtualized addresses that may be provided to the client computing devices 110-114 so that user space applications may access the storage allocated to the logical storage partitions. The address translations may require multiple levels of address mappings including logical address to virtual address, virtual address to physical address, or the like. In this way, applications running on client devices 110-114 may access logical or virtual address spaces and have those addresses translated to physical addresses for accessing physical locations of physical storage devices 120.

As mentioned above, in order to reduce the number of communications required to be exchanged between the virtual storage server 104 and the client computing devices 110-114, e.g., client computing device 110, the client computing device 110 may cache address translations for the client computing device' logical storage partition(s) in a local memory of the client computing device 110. In this way, the translations can be performed at the client computing device 110 and used to access the backend storage devices 120 via the server 104 without having to send additional communications to the virtual storage server 104 to obtain these translations with each storage access request.

Moreover, in order to ensure availability of data to the client computing devices 110-114, and to mitigate issues associated with device failures, the virtual storage server 104 may implement a file system on the backend storage devices 120 that facilitates the use of mirror copies of data, e.g., RAID 1. That is, the same set of data or storage address spaces associated with a first set of storage devices in the backend storage 120 may be replicated or mirrored on another set of storage devices within the backend storage 120 or in another backend storage, such as network attached storage 108, for example. As such, logical storage partitions associated with client computing devices 110-114 may encompass portions of data in multiple mirror copies and thus, the client computing devices 110-114 may cache address translations directed to multiple mirror copies of data. For example, a logical storage partition for a client 110 may have two physical partitions, one for each of two mirror copies of data on the backend storage device 120. As such, the client 110 would need to cache address translations for translating addresses to both physical partitions, e.g., address translations to physical storage locations in both mirror copies.

In facilitating the use of mirror copies by the file system of the backend storage devices 120, the virtual storage server 104 provides file system functionality for adding and removing mirror copies. As each client computing device may have one or more logical storage partitions mapping to different portions of different mirror copies of data in the backend storage devices 120, managing the mirror copies of data as they are added and removed, as well as the management of client cached address translations, becomes an arduous task. That is, cache coherency amongst the client computing devices 110-114 becomes complicated.

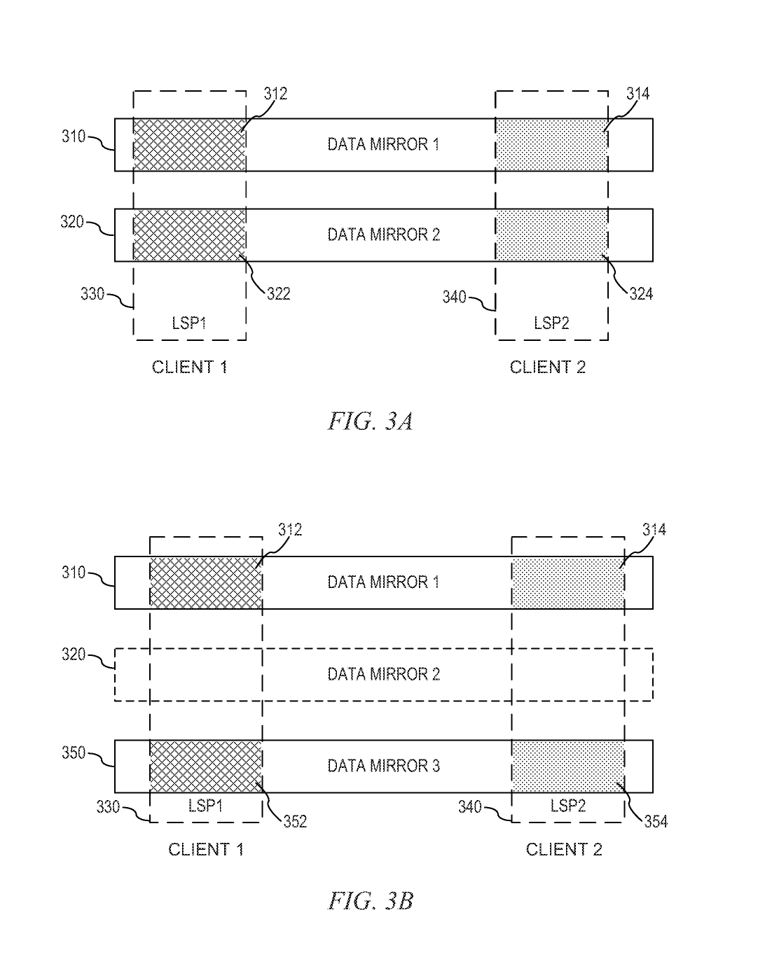

FIG. 3A is an example diagram illustrating a plurality of logical storage partitions associated with a plurality of mirror copies of data in accordance with one illustrative embodiment. As shown in FIG. 3A, the file system of a virtual storage server may support multiple mirror copies of data so as to ensure availability of data, provide support for disaster recovery, and the like. As such, a first data mirror 310 may be referred to as the “production environment” mirror copy of data since it is the mirror copy of data to which writes of data may be performed with the second data mirror 320 being a “backup” or “redundant” mirror copy that stores a copy of the data in the production environment mirror copy 310 for purposes of availability and disaster recovery, e.g., if a physical storage device associated with data mirror 310 fails, the data has already been replicated to the physical storage devices associated with data mirror 320 so that the data may be accessed from data mirror 320.

In this example, in order to provide access capabilities to client 1 for accessing the data on storage devices associated with logical storage partition 330, the virtual storage server may provide client 1 with address translations for accessing the portions of the storage devices storing both mirror copies 310, 320, which are allocated to the logical storage partition 330. That is, address translations for data stored in physical storage devices associated with the logical or virtual addresses corresponding to regions 312 and 322 of data mirrors 310 and 320, respectively, may be provided to client 1 and may be cached by client 1. The regions 312 and 322 may correspond to physical partitions of the storage devices of the backend storage that are associated with the logical storage partition 330. When allocating such physical partitions to logical storage partitions, performing application input/output (I/O) operations, or the like, the virtual storage server may provide address translations to client computing devices associated with the logical storage partitions.

Similarly, as shown in FIG. 3A, a second client computing device may have its own second logical storage partition 340 which has been allocated physical partitions 314 and 324 on storage devices of a backend storage, with these physical partitions 314 and 324 being associated with the two mirror copies of data 310 and 320, respectively. In a similar manner, the virtual storage system may have provided address translations to client 2 which are cached in a local memory of client 2 for use in performing I/O operations with the client's logical storage partition.

FIG. 3B illustrates an example scenario in which the second data mirror has been removed and a new mirror copy of data has been added in accordance with one illustrative embodiment. A mirror copy of data may be added for data redundancy in the case of a copy of data becoming corrupt, unavailable due to disk failure, or the like. A mirror copy of data may be removed for various reasons, such as reasons associated with redundancy being provided by other mirror copies, by the hardware itself such that a software based redundancy is not needed, or the like.

As shown in FIG. 3B, with the removal of data mirror 320, the address translations pointing to data mirror 320 are no longer valid. Instead, new address translations are provided that point to data mirror 350 with new physical partition, or region, 352 being used along with physical partition 312 in data mirror 310 to provide storage support for logical storage partition 330. Similarly, new physical partition 354 is used along with physical partition 314 to provide storage support for logical storage partition 340.

It should be appreciated that since the clients 1 and 2 in this scenario cache the address translations to the physical partitions 312, 322, 352 and 314, 324, and 354 locally, as data mirrors 310-320 and 350 are removed and added to logical storage partitions 330, the cached address translations may become stale or no longer valid. In a system where there are a large number of client computing devices using shared storage via a virtual storage system, the management of cache coherency across this large number of client computing devices can be time consuming, complex, and daunting.

The illustrative embodiments provide a mechanism for maintaining cache coherence of address translations for clustered file systems that utilize data mirroring while doing so without blocking application I/O operations. In particular, the mechanisms of the illustrative embodiments utilize a cache buffer allocation scheme based on a current number of mirror copies that provides the ability for in-flight, or “old” I/O operations to continue to use “old” cached address translations while new I/O operations utilize new cached address translations at the client. Within the client computing device, buffers in the cache that utilize “old” cached address translations are only removed after all references to that buffer have been released, i.e. the memory associated with the buffer has been freed, and only in response to a client thread searching the cache for “old” cache address translations in response to the virtual storage server informing the client of a change in the number of mirror copies of data. Thus, in-flight data access I/O operations are permitted to complete using the old address translations, either successfully or unsuccessfully, while new I/O operations make use of the new address translations using the current number of mirror copies.

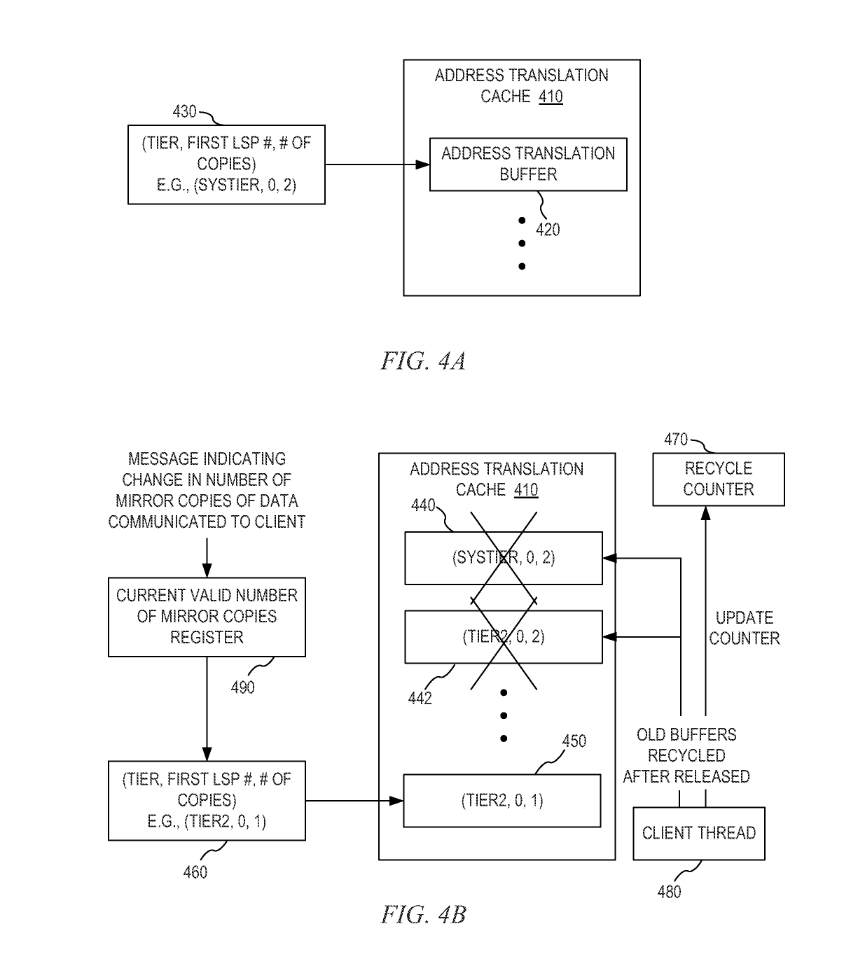

FIG. 4A is an example diagram illustrating a cache buffer allocation scheme that may be implemented by a client computing device to cache address translations in accordance with one illustrative embodiment. To further illustrate the operation of the illustrative embodiments, it will be assumed for purposes of this explanation, that a scenario exists in which there are two mirror copies of data present on backend storage associated with a virtual storage server and that an application running on a client computing device has initiated I/O operations with the virtual storage server such that address translations for accessing data stored in the physical partitions in these mirror copies of data have been cached in an address translation cache 410 of the client computing device. It should be appreciated that the address translations are cached in an address translation buffer 420 of the address translation cache 410. Each buffer may store an address translation for multiple logical storage partitions.

The buffers 420 are allocated from the address translation cache 410, such as by an operating system Application Program Interface (API) which may be called by a cache manager module or the like, using a cache key 430 the comprises a tier, a first logical storage partition (LSP) number (or buffer block number), and a currently valid number of mirror copies of data. It should be appreciated that one or both of the tier and first LSP number (or buffer block number) portions of the cache key may not be used in every illustrative embodiment. In some cases, only the tier identifier is used, and in other cases only the first LSP number may be used, in conjunction with the current valid number of mirror copies of data when generating a cache key 430 for indexing into the address translation cache 410 to identify a corresponding buffer 420. Other values may be used to generate the address translation cache key 430 as long as the current valid number of mirror copies is also used for this purpose and is part of the cache key 430.

To better understand the example tuple used as a cache index into the address translation cache 410, consider that each buffer in the address translation cache 410 is a piece of memory that stores the address translations for one or more logical storage partitions. Each buffer has a cache key associated with it. Each logical storage partition has a logical storage partition number associated with it that ranges from 0 to N with the value of N depending on the size of the particular tier in the backend storage system, with the tier being a group of physical storage devices in the backend storage system. A virtual disk is made up of physical disks in a tier. The address translation cache 410 can thus be viewed as a hash table which contains one or more buffers hashed using the cache key associated with the buffer. A cache manager component can implement this caching mechanism.

As such, the tier identifier mentioned above may only be used if there is more than one tier in the backend storage system. The logical storage partition number (or buffer block number) is determined based on the number of entries in the buffer. For example, if the buffer contains 32 logical translation entries, then the logical storage partition number (or buffer block number) 0 contains translations for logical storage partition number 0 to 31. Logical storage partition number (or buffer block number) 1 contains translations for logical storage partition number 32 to 63, and so on.

The number of copies portion of the cache key indicates how many physical copies of data are valid for a logical storage partition. It should be appreciated that rather than using an actual number of copies, a generation number may be utilized instead to identify the current number of copies of data valid for a logical storage partition. That is, the virtual storage server may have a persistent generation counter that is updated each time a change in the number of mirror copies is requested. In such a case, the generation counter value may be used instead of the number of copies referred to herein. However, for purpose of the following description, it will be assumed that a number of copies is used as part of the cache key.

With the mechanisms of the illustrative embodiments, the current valid number of mirror copies is communicated to the client computing device by the virtual storage server during initialization or in response to a change in the number of mirror copies being used by the virtual storage server. Thus, in response to the virtual storage server changing the number of mirror copies, either by removing or adding mirror copies of data, the virtual storage server sends a message to client computing devices registered with the virtual storage server to inform them of the change in the current valid number of mirror copies of data being maintained by the virtual storage server. This current valid number of mirror copies is stored by the client computing device in a well known location, such as a system register 490, or the like, and uses this current valid number of mirror copies to identify buffers in the address translation cache 410 that are stale or invalid because they store address translations for an “old” number of mirror copies of data, and to identify buffers within the address translation cache 410 that are valid as well as allocate new buffers for new address translations.

In the running example above and shown in FIG. 3A, there are currently two valid mirror copies of data associated with the LSP of the client computing device with the first LSP being LSP 0. As such, a cache key 430 may be used to allocate the buffer 420 where the cache key has the values (SYSTIER, 0, 2) for storing address translations for a system tier (SYSTIER) of the backend storage. Thus, sets of address translation buffers may be established within the address translation cache for each combination of tier identifier and starting LPAR number within that tier. The current valid number of mirror copies of data is used as a validation mechanism for validating the buffers and identifying buffers for recycling as described hereafter.

FIG. 4B is an example diagram of an address translation cache after a change in the number of mirror copies of data has been communicated to the client computing device in accordance with one illustrative embodiment. As shown in FIG. 4B, when a change in the number of mirror copies of data being maintained by the virtual storage server is communicated to the client computing device, the change in number of mirror copies of data invalidates the address translations cached in the client computing device. For example, if a system administrator or the like removes a mirror copy of data, the removal command is processed by the virtual storage server in a known manner with the virtual storage server determining if the copy removal is possible and then marking the mirror copy of data that is to be removed as stale or invalid with regard to each logical storage partition that references that mirror copy of data. The virtual storage server then changes its own metadata reflecting the current valid number of mirror copies of data to reflect the removal of the mirror copy of data, e.g., changing from 2 mirror copies to 1 copy of data, and updates the metadata of each logical storage partition to represent the logical storage partition as having a single copy. The virtual storage server then performs its normal operations for removal of the mirror copy of data which are known processes and thus, will not be described in detail herein.

In addition to the updates to metadata made by the virtual storage server, the virtual storage server also sends a message to all client computing devices registered with the virtual storage server requesting them to release old address translations that the client computing devices have cached and informing them of the current valid number of mirror copies of data. In this example, since a mirror copy of data has been removed, the current number of valid mirror copies has changed from 2 to 1.

At the client computing device, in response to receiving the message from the virtual storage server, the client computing device first stores in a register or other well known location in memory, the current valid number of mirror copies of data, e.g., overwriting a previous number of valid copies. Thus, the value of “2” in this register or storage location would be replaced with the value of “1” in the example. After the updating or overwriting of this value in the register or storage location, future address translations cached in the address translation cache 410 will use the new value until it is later changed. Thus, for example, any address translations cached due to I/O operations being performed by applications running on the client would utilize the new current valid number of mirror copies, i.e., the value “1” in this example, when indexing into the address translation cache 410 for allocating buffers or accessing cached address translations.

In response to receiving the message from the virtual storage server, a client thread 480, which may have been spawned by a device driver, may be a thread listening for the message on a particular socket, or the like, traverses each of the buffers 440, 442, and 450 in the address translation cache 410 to analyze the cache key 430, 460 associated with the buffer 440, 442, 450. In response to finding a buffer whose cache key includes a number of mirror copies that does not match the current valid number of mirror copies stored in the register, memory location, or the like, of the client computing device, the buffer is marked for recycling after all references on the buffer are released, e.g., in-flight I/O operations. A counter 470 that updates a count of the number of buffers in the address translation cache 410 that are marked for recycling may be incremented as each such buffer is encountered. Thereafter, the counter 470 may be decremented as buffers are recycled. This counter 470 may be reinitialized in response to a next message from the virtual storage server indicating a change in the valid number of mirror copies.

Thus, for example, as shown in the depicted example, buffers 440 and 442 are identified through the analysis of the buffers as having a number of copies portion of their corresponding cache keys that refers to a number of copies that does not match the current valid number of mirror copies, e.g., the “old” number of mirror copies is “2” whereas the current valid number of mirror copies is “1.” As a result, these buffers 440, 442 are marked for recycling and the counter 470 is incremented for each buffer 440, 442, such that the counter 470 now stores the value of “2” indicating two buffers are marked for recycle. As each buffer 440, 442 is released, i.e. there are no more outstanding I/O operations that make reference to the address translations stored in the buffers 440, 442, the buffers 440, 442 are recycled and the counter 470 is updated accordingly by decrementing the count value of the counter 470 until it reaches a minimum value indicating that all of the marked buffers have been recycled. Recycling of buffers involves ensuring that no other processes are using the buffer and calling an operating system API to release the corresponding memory, i.e. freeing the memory for reuse. It should be appreciated that freeing the memory associated with the buffer could alternatively comprise utilizing a free list without giving back the memory to the operating system in which case the cache manager may simply put the buffer on the free list which can be used by another process.

The client thread 480, after traversing the address translation cache 410 and marking all buffers that have an inaccurate number of mirror copies in their corresponding cache key for recycling, waits for all of the marked, or “old”, buffers to be recycled. The completion of the recycling of the marked buffers is signaled when the counter 470 reaches a minimum value, e.g., zero. Once all of the marked buffers are released by the client computing device and are recycled, a positive response is sent back to the virtual storage server indicating to the virtual storage server that the release of old translations has been completed.

In response to the virtual storage server receiving a completion response from all of the client computing devices, the virtual storage server performs operations to finish the removal of the mirror copy. If one or more client computing devices do not return a positive response, or send a negative response, then the virtual storage server can recover by expiring the client computing device's lease or allocation of storage resources which will clear the cache.

It should be appreciated that while the above description of the illustrative embodiments focuses on an example scenario in which a mirror copy of data is removed, similar operations and functionality may be employed when a mirror copy of data is added to the backend storage and allocated to logical storage partitions. Furthermore, while the examples above are described with regard to only two mirror copies of data, for simplicity of the description, and only two client computing devices with two associated logical storage partitions, the illustrative embodiments are not limited to such. To the contrary, any number of mirror copies of data, client computing devices, and logical storage partitions may be used without departing from the spirit and scope of the present invention.

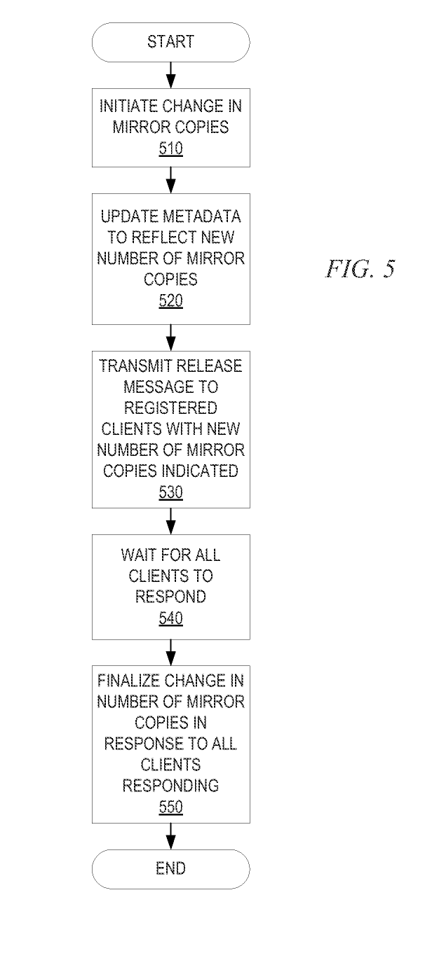

FIG. 5 is a flowchart outlining an example operation of a virtual storage server when performing a change in a number of mirror copies of data maintained by the backend storage in accordance with one illustrative embodiment. As shown in FIG. 5, the operation starts by initiating a change in a number of mirror copies of data (step 510). As noted above, this may involve the addition or removal of a mirror copy from a set of mirror copies of data maintained and allocated to logical storage partitions of one or more client computing devices.

In response to the initiating of the change in number of mirror copies of data, the virtual storage server updates metadata associated with the virtual storage server and logical storage partitions hosted by the virtual storage server to reflect the new number of mirror copies (step 520). The virtual storage server then transmits a message to each of the client computing devices registered with the virtual storage server requesting that the client computing devices release their old cached address translations and informing the client computing devices of the new number of mirror copies of data (step 530).

The virtual storage server then waits for all client computing devices to respond with a positive response message indicating that all of their old cached address translations have been released (step 540). In response to receiving a positive response from all client computing devices, the virtual storage server performs operations to finalize the change to the number of mirror copies of data in the backend storage (step 550). The operation then terminates.

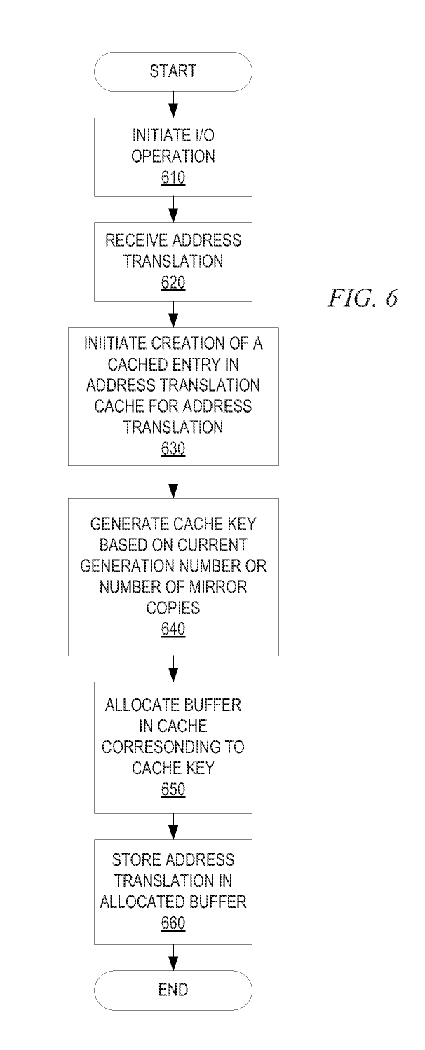

FIG. 6 is a flowchart outlining an example operation of a client computing device when caching an address translation for an I/O operation in accordance with one illustrative embodiment. As shown in FIG. 6, the operation starts with initiating an I/O operation (step 610). An address translation for performing the I/O operation is returned to the client computing device by the virtual storage server (step 620) and the client computing device initiates the creation of a cached entry in an address translation cache for the address translation (step 630). A cache key for a buffer is generated based on a tier identifier, a first logical storage partition number, and a current valid number of mirror copies of data, or generation number in some illustrative embodiments (step 640). A buffer of the address translation cache corresponding to the generated cache key is allocated to store the address translation (step 650) and the address translation is cached in the buffer (step 660). The operation then terminates.

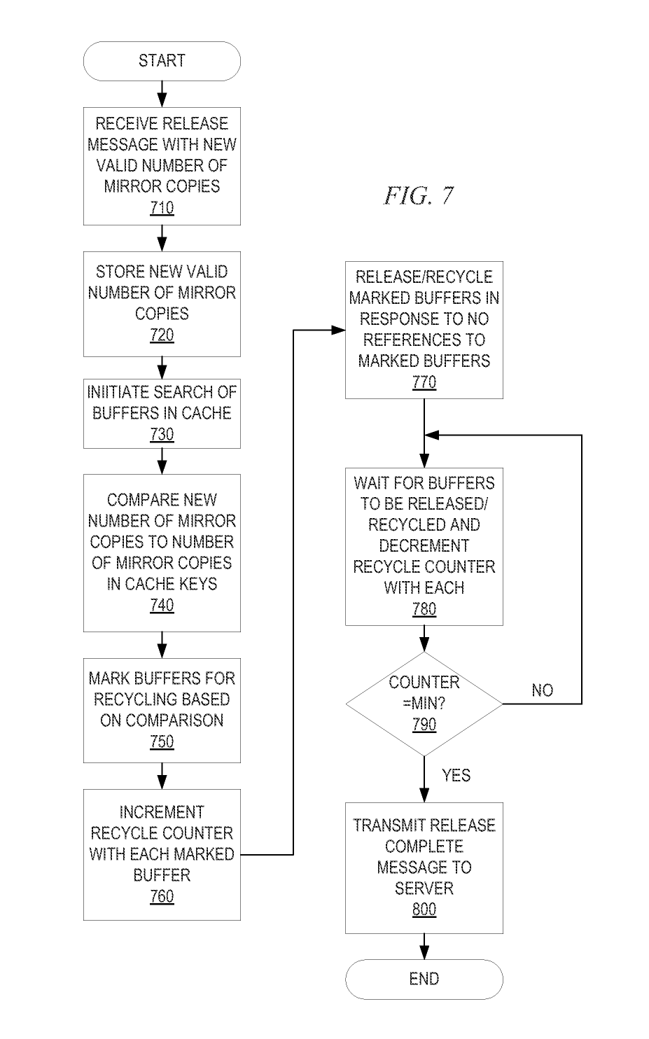

FIG. 7 is a flowchart outlining an example operation of a client computing device for managing an address translation cache in response to a change in a number of mirror copies of data at a backend store in accordance with one illustrative embodiment. As shown in FIG. 7, the operation starts with receiving a message from a virtual storage server to release old cached address translations and providing a new valid number of mirror copies of data (step 710). The new valid number of mirror copies is stored in the client computing device (step 720) and a search of the buffers of the address translation cache is initiated (step 730). The new valid number of mirror copies is compared against the number of mirror copies in the cache keys for the buffers of the address translation cache (step 740) to identify buffers whose corresponding cache keys comprise a number of mirror copies different from the new valid number of mirror copies, which are then marked for recycling (step 750). A counter is incremented for each buffer marked for recycling (step 760).

Marked buffers are released and recycled in response to all outstanding I/O operations referencing the buffer completing and thus, no outstanding I/O operation references the address translation stored in the buffer (step 770). The operation waits for buffers to be released and decrements the counter as each marked buffer is released (step 780). In response to the counter reaching an initial or minimum value (step 790), the client computing device transmits a release complete message to the virtual storage server (step 800). The operation then terminates.

Thus, while a change in number of mirror copies of data is being performed at the virtual storage server, I/O operations are permitted to continue to be processed without blocking the I/O operations. Currently in-flight I/O operations are permitted to complete using the old address translations in the old buffers of the address translation cache while new I/O operations will reference new address translations cached in buffers allocated using a currently valid number of mirror copies. By including the valid number of mirror copies in the cache key for the buffers storing the address translations in the address translation cache, a mechanism is provided for identify old and new address translations cached in the buffers of the address translation cache and facilitates the recycling of old address translation buffers in the address translation cache.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system comprising a processor and an address translation cache, for caching address translations in the address translation cache, the method comprising:
receiving, by the data processing system, an address translation from a server computing device to be cached in the data processing system;
generating, by the data processing system, a cache key based on a current valid number of mirror copies of data maintained by the server computing device;
allocating, by the data processing system, a buffer of the address translation cache, corresponding to the cache key, for storing the address translation;
storing, by the data processing system, the address translation in the allocated buffer; and
performing, by the data processing system, an input/output operation using the address translation stored in the allocated buffer.

2. The method of claim 1, wherein the cache key comprises a combination of the current valid number of mirror copies and at least one of a tier identifier or a logical storage partition number.

3. The method of claim 1, further comprising:
receiving a message from the server computing device indicating a change in the current valid number of mirror copies of data, wherein the message specifies a new current valid number of mirror copies.

4. The method of claim 3, further comprising:
releasing buffers of the address translation cache based on a comparison of the new current valid number of mirror copies to a number of mirror copies indicated in corresponding cache keys of the buffers.

5. The method of claim 4, wherein releasing buffers of the address translation cache comprises, for each buffer in the address translation cache:
determining if the comparison of the new current valid number of mirror copies matches the number of mirror copies indicated in a cache key corresponding to the entry; and
in response to the comparison indicating that the new current valid number of mirror copies does not match the number of mirror copies indicated in the cache key corresponding to the entry, releasing the buffer and freeing memory associated with the buffer.

6. The method of claim 3, wherein the message is transmitted by the server computing device in response to initiating a change in the current valid number of mirror copies of data maintained by a backend storage system associated with the server computing device.

7. The method of claim 6, wherein data access operations performed by the data processing system targeting data on the backend storage system are not disrupted during the change in the current valid number of mirror copies of data maintained by the backend storage system associated with the server computing device.

8. The method of claim 4, further comprising:
determining, by the data processing system, if all buffers having a different number of mirror copies in the cache key from the new current valid number of mirror copies have been released; and
issuing, by the data processing system, to the server computing device a notification message indicating buffer release operations have completed, wherein the server computing device completes changing the current number of valid mirror copies of data maintained on the backend storage system associated with the server computing device in response to receiving the notification message from the data processing system.

9. The method of claim 1, wherein the current valid number of mirror copies is indicated as one of a number of mirror copies currently being maintained on a backend storage system of the server computing device or a generation indicator.

10. The method of claim 1, wherein the server computing device is a virtual storage server.

11-20. (canceled)
